(19) United States
(12) Patent Application Publication
(10) Pub. No.: US 2019/0049089 A1
(43) Pub. Date: Feb. 14, 2019

(54) LIGHTING MODULE AND HEADLIGHT

(71) Applicant: OSRAM GmbH, Munich (DE)

(72) Inventors: Thomas Feil, Iggingen (DE); Martin Petzold, Ellwangen (DE); Daniel Weissenberger, Giengen (DE)

(21) Appl. No.: 16/056,571

(22) Filed: Aug. 7, 2018

(30) Foreign Application Priority Data
Aug. 9, 2017 (DE) 102017213871.8

(51) Int. Cl. F21S 45/47; F21V 29/70; F21S 41/141

(52) U.S. Cl. CPC F21S 45/47; F21S 41/141; F21V 29/70

(57) ABSTRACT

A lighting module includes a housing, in which a circuit board having at least one lighting means is arranged. The housing has a housing opening, via which radiation from the at least one lighting means can be emitted. A heat sink is provided to dissipate heat from the circuit board. For the thermal relief of the circuit board, an additional circuit board is provided in the housing, which is fitted with electric components for the operation of the lighting module and is arranged at a distance from the circuit board.

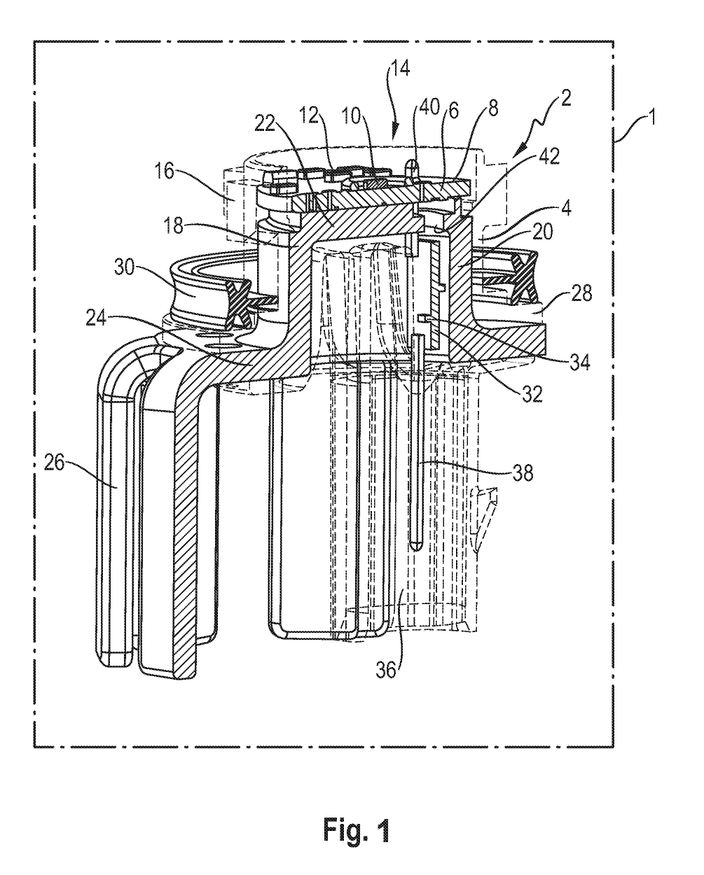

### CROSS-REFERENCE TO RELATED APPLICATION

This application claims priority to German Patent Application Serial No. 10 2017 213 871.8, which was filed Aug. 9, 2017, and is incorporated herein by reference in its entirety.

### TECHNICAL FIELD

Various embodiments relate generally to a lighting module. In addition, various embodiments relate to a headlight having such a lighting module.

### BACKGROUND

Headlights for vehicles are known, wherein standards can be provided for such headlamps, such as, for example, standards from the International Technical Commission (IEC). Therein, for example, standards can be provided for an “exchangeable light source (XLS)”. Such a light source can be used, for example, for an additional lighting function in a vehicle, such as for a fog light function. For instance, the standardization can relate to referencing and an anti-rotation safeguard of the light source in the headlight.

The light source is configured, for example, as a light module with semiconductor light sources in the form of light-emitting diodes (LEDs). To operate the semiconductor light sources, peripheral electrical components are needed. The semiconductor light sources and the peripheral components are arranged on a circuit board. Heat is dissipated via a heat sink. Waste heat generated by the peripheral components is generally undesired and contributes to additional heating of the semiconductor light sources, which leads to a drop in efficiency. In order to manage the thermal load, provision can be made to blacken the heat sink in a costly manner. Alternatively or additionally, more expensive electronic components with lower power losses can be used.

### SUMMARY

A lighting module includes a housing, in which a circuit board having at least one lighting means is arranged. The housing has a housing opening, via which radiation from the at least one lighting means can be emitted. A heat sink is provided to dissipate heat from the circuit board. For the thermal relief of the circuit board, an additional circuit board is provided in the housing, which is fitted with electric components for the operation of the lighting module and is arranged at a distance from the circuit board.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings. The invention is to be explained in more detail below by using an embodiment. The individual figure shows a lighting module in a perspective longitudinal section.

### DESCRIPTION

The following detailed description refers to the accompanying drawings that show, by way of illustration, specific details and embodiments in which the invention may be practiced.

Various embodiments devise a lighting module and a headlight with which, in each case e.g. with at least a constant installation space, thermal loading of at least one lighting means is comparatively low, in a manner which is simple and economical in device terms.

In various embodiments, a lighting module or a lamp or a light module which has a housing is provided. A circuit board having at least one lighting means can be arranged in said housing. The housing preferably has a housing opening, via which radiation from the lamp can emerge. In order to cool the circuit board and the at least one lighting means, a heat sink can be provided. In addition, an additional circuit board or an additional board may be arranged in the housing for the thermal relief of the circuit board. Said additional circuit board is then preferably fitted with electric components for the operation of the lighting module and can, for example, be arranged at a distance from the circuit board.

This solution may have the effect that thermal relief of the circuit board having the at least one lighting means is devised in a simple way in device terms, in that at least one electronic component or multiple electronic components are not arranged on the circuit board but on the additional circuit board. The at least one additional circuit board, which can be connected electrically to the circuit board, can be arranged flexibly in the housing since, as distinct from the circuit board, it is possible for no lighting means to be provided on the additional circuit board, and therefore a housing opening can also be disregarded. As a result of the possibility of the flexible arrangement of the additional circuit board, a requirement for installation space is extremely low, which means, for example, that external dimensions of the lighting module can remain unchanged. This may be advantageous since usually, e.g. when the lighting module is used in a vehicle, only a very limited installation space is available. Since at least one electronic component is now no longer arranged on the circuit board, the at least one lighting means is no longer thermally loaded or at least less thermally loaded by the at least one electronic component, by which means the efficiency of the lighting means is increased. As a result of the thermal relief of the at least one lighting means, the operational reliability is also increased, since in this way a probability of failure of the lighting means decreases. In other words, a lighting module is now advantageously devised in which, with an extremely low requirement for installation space, thermal relief of the at least one lighting means is provided by arranging the additional circuit board in the housing. In addition, the arrangement of the additional circuit board leads to a less stressed space situation on the circuit board, which means, for example, the electronic components arranged thereon can be spaced further apart from one another with a constant installation space, which likewise reduces and relieves the thermal loading of the at least one lighting means. Thus, the introduction of an additional board leads to the reduction in an input of thermal power on the circuit board. In addition, the EMC interference can be reduced by the introduction of an additional board.

In various embodiments, the heat sink is arranged between the additional circuit board and the circuit board. Thus, the circuit boards are separated spatially via the heat sink, for which reason, for example, waste heat from the additional circuit board is led substantially to the heat sink.

In various embodiments, the housing is configured simply in device terms as an injection molded plastic part. The additional circuit board can then be overmolded simply in device terms by the housing, e.g. overmolded completely. This is made possible by the fact that e.g. no lighting means is provided on the additional circuit board. Thus, the additional circuit board can be arranged in the lighting module economically and simply in device terms.

It is conceivable for the circuit board to be overmolded by the housing economically and simply in device terms and/or to be connected by the heat sink to at least one fixing means.

The housing can be configured in the form of a socket and have an axial socket opening as housing opening, via which the lighting means can then emit the radiation. The circuit board can then extend approximately transversely with respect to the longitudinal axis of the socket-shaped housing, which means that the at least one lighting means can radiate in the direction of the housing opening in a simple way. The circuit board is preferably arranged in the end region of the socket-shaped housing, close to the housing opening.

The circuit board can have a fixing side, to which the at least one lighting means is then fixed and contacted electrically. It is conceivable that at least one electric component is fixed and contacted electrically to the circuit board, e.g. on the fixing side, in addition to the at least one lighting means.

Formed on the housing, for example simply in device terms, is a part of a plug connection, in order to contact the lighting means electrically. The part of the plug connection can thus likewise, for example, be formed via a plastic injection molding process. The plug connection may be arranged on a rear side of the circuit board, pointing away from the fixing side. In various embodiments, the heat sink can be provided between the part of the plug connection and the circuit board. It is at least conceivable that the additional circuit board is arranged on sides of the part of the plug connection, simply in device terms. The additional circuit board can thus be incorporated simply in device terms, for example in the already present power supply path from the part of the plug connection to the circuit board. The part of the plug connection is, for example, a socket, into which a plug can be inserted.

Simply in device terms, the heat sink can likewise be overmolded at least partly by the housing. The heat sink can then be provided, for example, as an insert part of a die in a plastic injection molding process. The circuit board and/or the additional circuit board can likewise be provided as insert parts.

The heat sink can have a socket-shaped heat-sink section which can then extend, at least partly in the housing, e.g. approximately coaxially with respect to the housing. The bottom section of the socket-shaped heat sink then may extend along a rear side of the circuit board, facing away from the fixing side, in order to dissipate heat from the circuit board over a large area. The bottom section can rest on the circuit board, e.g. somewhat, and/or be connected to the circuit board via a thermal conduction means or fixing means.

The additional circuit board may be provided within the socket-shaped heat-sink section. It is thus possible, in a simple manner in device terms, for external dimensions of the lighting module to remain unchanged. Furthermore, the additional circuit board may extend along the socket-shaped heat-sink section. It is thus possible in a simple manner in device terms for heat to be conducted to the heat sink over a large area. In various embodiments, the additional circuit board is then thermally connected to the heat sink, wherein for example thermal conduction means may be provided.

In various embodiments, the heat sink can project out of the housing with a thermally conductive structure, e.g. with cooling ribs. The heat sink may have a radial collar, e.g. extending radially away from its lateral section at the end side and projecting out of the housing. From said radial collar, radially external cooling ribs can then extend in a direction away from the circuit board, e.g. axially. Thus, viewed in the direction of its longitudinal axis, the heat sink can have the bottom section on one side and the radial collar having the cooling ribs on the other side. The cooling ribs and the radial collar are arranged approximately in a pot shape. In addition, the cooling ribs can engage around the part of the plug connection formed on the housing, wherein the latter can be protected from the influence of mechanical forces via the heat sink. It is conceivable that at least one of the cooling ribs is implemented as a heat pump (heat pipe), which ensures better heat dissipation.

In various embodiments, the circuit board and the additional circuit board are connected electrically via the contact opening of the heat sink, via one or more electric contact/s. In various embodiments, the at least one electric contact is configured as a contact pin, which extends from the additional circuit board, e.g. axially, via the contact opening. The contact pin can then, for example, dip into a contact receptacle of the circuit board. Provision can further be made for at least one contact pin to extend from the additional circuit board, e.g. in the axial direction, as part of the plug connection. It is thus conceivable that the additional circuit board is arranged simply in device terms between the contact pin connected to the circuit board and the contact pin which is part of the plug connection. In various embodiments, two contact pins, which are part of the plug connection, are provided, which can then extend, e.g. somewhat, parallel at a distance from each other. Furthermore, two contact pins, e.g. extending parallel at a distance, can also be provided to connect the additional circuit board to the circuit board.

The additional circuit board can be arranged between the part of the plug connection and the heat sink, as seen in the radial direction of the housing.

In various embodiments, the lighting means provided is at least one light-emitting diode (LED). The thermal relief of the circuit board is particularly advantageous for the latter, since its efficiency rises with decreasing thermal loading.

An LED or light-emitting diode can be present in the form of at least one singly housed LED or in the form of at least one LED chip which has one or more light-emitting diodes, or in the form of a micro-LED. It is possible for multiple LED chips to be mounted on a common substrate (“submount”) and form an LED or, individually or jointly, to be fixed for example to a circuit board (e.g. FR4, metal core circuit board, etc.) (“CoB”=Chip on Board). The at least one LED can be equipped with at least one dedicated and/or common optical unit for beam guidance, for example with at least one Fresnel lens or a collimator. Instead of or in addition to inorganic LEDs, for example based on AlInGaN or InGaN or AlInGaP, in general organic LEDs (OLEDs, e.g. polymer OLEDs) can also be used. The LED chips can be directly emitting or have a luminous substance mounted in front. Alternatively, the light-emitting component can be a laser diode or a laser diode arrangement. Also conceivably provided is an OLED luminous layer or multiple OLED luminous layers or an OLED luminous region. The emission wavelengths of the light-emitting components can lie in the ultraviolet, visible or infrared spectral range. Light-emitting components can additionally be equipped with a dedicated converter. In various embodiments, the LED chips emit white light in the standardized ECE white field of the automobile industry, for example implemented by means of a blue emitter and a yellow/green converter.

At least one electric component for regulating a constant luminous flux, e.g. in the relevant temperature range in the automotive sector from −40° C. to +125° C., and/or for protecting the lighting module and/or the at least one lighting means can be provided on the circuit board and/or on the additional circuit board.

Part of a bayonet fitting is preferably formed on the housing, in order to fix the lighting module in a mount, for example of a reflector, in a simple manner. The part of the bayonet fitting is preferably formed on the housing at the level of the circuit board. In addition, a sealing ring can be provided, which encloses the housing and is arranged between the part of the bayonet fitting and the radial collar of the heat sink, as seen in the axial direction.

The circuit board and/or the additional circuit board may be a circuit board formed of a flame-retardant composite material. This is formed, for example, from epoxy resin and/or glass fiber fabric. For example, the circuit board is an FR4 circuit board.

In various embodiments, a headlight is provided, e.g. for a vehicle, having a lighting module according to one or more of the preceding aspects. It can have a reflector, to which the lighting module can be connected. The headlight may be used as a fog light. Further possible uses are as a light source for a turn signal function and/or a brake light function and/or a rear light function and/or a daylight driving function and/or a position light function and/or combinations of the aforementioned and further functions. In such a headlight, the installation space is usually extremely small, for which reason the lighting module in various embodiments may be suitable for such a headlight.

The vehicle can be an aircraft or a water-bound vehicle or a land-bound vehicle. The land-bound vehicle can be a motor vehicle or a rail vehicle or a bicycle. In various embodiments, the vehicle is a truck or a passenger car or a motor cycle. The vehicle can also be configured as a non-autonomous or partly autonomous or autonomous vehicle.

The term “somewhat” can mean, for example, that there can be a deviation in the customary tolerances or up to 5%.

According to the single figure, a headlight 1, which is illustrated in simplified form by a dashed line, having a lighting module 2 is illustrated. The latter has a housing 4 made of plastic, which is configured somewhat in the form of a socket or approximately hollow-cylindrically. A circular circuit board 6 is inserted into the housing 4. Multiple comparatively flat LEDs 10 and further electric components 12 are arranged on a fixing side 8 of the circuit board 6. For simplicity, only one LED and one electric component are provided with a reference designation. The circuit board 6 is arranged at the end side of the housing 4 and extends approximately transversely with respect to a longitudinal axis of the housing 4. The fixing side 8 here points in the direction of a housing opening 14, via which the LEDs 10 can then emit light. A part of a bayonet fitting 16 is formed radially on the outside of the housing 4, at the height of the circuit board 6.

A heat sink 18 is also overmolded by the housing 4. Said heat sink has a pot-shaped heat-sink section 20, which has a bottom section 22 extending parallel to the circuit board 6. From the bottom section 22, the heat-sink section 20 then extends in a direction away from the circuit board 6, that is to say in a direction opposite to the emission direction of the LEDs 10. In its end section remote from the circuit board 6, a radial collar 24 which extends radially outward is formed on the heat-sink section 20. The heat sink 18 projects out of the housing 4 via the radial collar 24. Cooling ribs 26 are then formed in the manner of fingers radially on the outside of the radial collar 24 and extend approximately parallel at a distance from one another and in a direction away from the circuit board 6. Seen in the axial direction, the radial collar 24 is engaged around on both sides by the housing 4 by way of a housing collar 28. A sealing ring 30 is then supported on a side of the housing collar 28 pointing toward the circuit board 6.

Radially inwardly from the heat-sink section 20, an additional circuit board 32 is arranged and overmolded by the housing 4. Electric components 34 can be arranged on one side or on both sides of said additional circuit board. Adjacent to the additional circuit board 32, a plug socket 36 is formed on the housing 4. Said plug socket extends in the axial direction away from the circuit board 6. Contact pins 38 originating from the housing 4, of which one is shown in the figure, extend into the plug socket 36. The contact pins 38 are connected electrically and mechanically to the additional circuit board 32. In addition, two further contact pins 40, of which only one is illustrated in the sectional view according to the figure, extend from the additional circuit board 32. The contact pins 40 are then inserted into a respective contact receptacle of the circuit board 6 and connected electrically and mechanically to the latter. To guide the contact pins 40 from the additional circuit board 32 toward the circuit board 6, a contact opening is formed in the bottom section 22 of the heat sink 18. The additional circuit board 32 is thus arranged in the lighting module 2 in a space-saving and compact manner between the contact pins 38 and 40.

Various embodiments disclose a lighting module having a housing, in which a circuit board having a lighting means is arranged. In addition to a heat sink, an additional circuit board is also provided, on which at least one electronic component for the operation of the lighting module is provided.

### LIST OF REFERENCE SIGNS

Headlight 1

Lighting module 2

Housing 4

Circuit board 6

Lighting means (LED) 10

Electric component 12

Housing opening 14

Bayonet fitting 16

Heat sink 18

Heat-sink section 20

Bottom section 22

Radial collar 24

Cooling ribs 26

Housing collar 28

Sealing ring 30

Additional circuit board 32

Electric component 34

Contact pin 38

Contact pin 40

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lighting module, comprising:
a housing, in which a circuit board having at least one lighting means is arranged,
wherein the housing has a housing opening, via which radiation from the at least one lighting means can be emitted, wherein a heat sink is provided to dissipate heat from the circuit board,
wherein, for the thermal relief of the circuit board, an additional circuit board is provided in the housing, which is fitted with electric components for the operation of the lighting module and is arranged at a distance from the circuit board.

2. The lighting module of claim 1,
wherein the heat sink is arranged between the additional circuit board and the circuit board.

3. The lighting module of claim 1,
wherein the additional circuit board is arranged in the housing as a bridge between contact pins for electricity contacting the circuit board.

4. The lighting module of claim 1,
wherein the housing is configured as an injection molded plastic part and the additional circuit board is overmolded by the housing.

5. The lighting module of claim 1,
wherein the housing is socket-shaped and an axial socket opening forms the housing opening.

6. The lighting module of claim 1,
wherein the circuit board has a fixing side, on which the at least one lighting means is fixed and contacted electrically.

7. The lighting module of claim 1,
wherein the heat sink is overmolded by the housing.

8. The lighting module of claim 1,
wherein the heat sink has a socket-shaped heat-sink section, which extends at least partly in the housing, wherein the additional circuit board is provided within the socket-shaped heat-sink section.

9. The lighting module of claim 1,
wherein at least one light-emitting diode is provided as lighting means.

10. The lighting module of claim 1,
wherein at least one electric component for at least one of regulating a constant luminous flux or for protecting the lighting module is provided on the circuit board and/or on the additional circuit board.

11. A headlight, comprising:
a lighting module, comprising:
a housing, in which a circuit board having at least one lighting means is arranged,
wherein the housing has a housing opening, via which radiation from the at least one lighting means can be emitted, wherein a heat sink is provided to dissipate heat from the circuit board,
wherein, for the thermal relief of the circuit board, an additional circuit board is provided in the housing, which is fitted with electric components for the operation of the lighting module and is arranged at a distance from the circuit board.
